(19) United States
(12) Patent Application Publication
(10) Pub. No.: US 2006/0112490 A1
(43) Pub. Date: Jun. 1, 2006

(54) Mattress with chest aperture

(76) Inventor: Colleen Chausse, Manchester, NH (US)

Correspondence Address: LITMAN LAW OFFICES, LTD, PO BOX 15035, CRYSTAL CITY STATION, ARLINGTON, VA, 22215, US

(21) Appl. No.: 11/288,328

(22) Filed: Nov. 29, 2005

Related U.S. Application Data
(60) Provisional application No. 60/631,572, filed on Nov. 30, 2004.

(51) Int. Cl. A47C 27/14; A61G 13/12

(52) U.S. Cl. 5/690; 5/722; 5/725; 5/735

(57) ABSTRACT

The mattress with chest aperture is a cushion designed for use on a flat surface, such as a massage table. The mattress with chest aperture has at least a body support pad and may also include a chest support pad. The chest support pad is disposed under the body pad. The body pad has a selectively closable chest aperture extending through the pad that is closed by a chest insert pad. The chest insert pad is removed from the selectively closable chest aperture to form a chest cavity for massaging a person lying in a prone position. The top surface of the body pad, the chest insert pad, and the chest support pad may be an egg crate-like surface.

### CROSS-REFERENCE TO RELATED APPLICATION

This application claims the benefit of U.S. Provisional Patent Application Ser. No. 60/631,572, filed Nov. 30, 2004.

### BACKGROUND OF THE INVENTION

1. Field of the Invention

The present invention relates to mattresses and mattress pads, and more particularly to a mattress pad having an aperture for receiving the chest area of a person when lying in a prone position.

2. Description of the Related Art

Lying prone on a surface can be uncomfortable for individuals with a large chest. The chest sustains a great deal of stress and pressure, forcing the individual to sleep on their side or their back. In some situations, the individual cannot avoid lying in the prone position, for example, when receiving a back massage. Normally, massages are given on padded, flat massage tables that are covered with a vinyl or leather material. The table is generally satisfactory, especially when the user is lying in the supine position. The table, however, can be cold to the touch because of the material used on the table. A mattress pad is desired that can be used in conjunction with the massage table, or on any other surface, that will accommodate a person's chest when prone and will be thermally insulative.

Some forms of massage, e.g., stone massage, use hot and/or cold stones applied to various portions of the body in conjunction with a conventional massage. Typically, the stones are placed on the massage table, or onto a towel placed on the massage table, and covered with a towel. The pattern of stones may, for example, outline the position of the spine. A problem sometimes arises because the massage table has a flat surface, and the stones have a tendency to slide or shift position. A mattress pad adapted for supporting stones for stone massage therapy, such as LaStone® massage therapy, is also desirable.

Thus, a mattress with a chest aperture solving the foregoing problems is needed.

### SUMMARY OF THE INVENTION

The mattress with chest aperture is a cushion designed for use on a flat surface, such as a massage table. The mattress with chest aperture has at least a body support pad and may also include a chest support pad. The chest support pad is disposed under the body pad. The body pad has a selectively closable chest aperture extending through the pad that is closed by a chest insert pad. The chest insert pad is removed from the selectively closable chest aperture to form a chest cavity for massaging a person lying in a prone position.

The chest support pad extends beneath the chest cavity, such that when the chest insert pad is removed, the chest support pad lies between the cavity and the top surface of the massage table. Thus, when a person lies prone on the mattress, the person's chest will lie in the chest cavity and, if large enough, will touch the chest support pad that lies below. The chest cavity allows a person lying prone to position their chest within the cavity and lie comfortably without too much pressure being placed on their chest. The chest support pad is made of cushioned material to provide comfort to the person lying on the mattress and to prevent the chest from contacting the cold, tough surface of the massage table when the mattress is placed on a massage table. The chest support pad may be made from a flexible, resilient material such that the chest support pad may be substantially compressed by the person's chest. The chest support pad may be wedge-shaped to raise the patient's head, neck or shoulders for comfort during a long massage.

When the person lies in the supine position, the chest insert pad is placed in the selectively closable chest aperture to form a flat surface upon which the person can lie, so that there is no hole beneath the person's back, and the person's back is properly supported. Alternatively, the mattress may further have an egg crate-like surface. The egg crate-like surface is advantageous for several purposes, including retaining massage stones when undergoing a stone massage, for example, a LaStone® massage. The peaks and valleys of the egg crate-like surface prevent the stones from sliding and aid in positioning the stones at desired pressure points.

These and other features of the present invention will become -readily apparent upon consideration of the following specification and drawings.

### BRIEF DESCRIPTION OF THE DRAWINGS

FIG. 1 is an environmental, perspective view of a mattress with chest aperture according to the present invention.

FIG. 2 is an environmental side view, partially in section, of the mattress with chest aperture of FIG. 1.

FIG. 3 is an environmental, exploded perspective view of the mattress with chest aperture of FIG. 1.

FIG. 4 is a bottom perspective view of the mattress with chest aperture of FIG. 1.

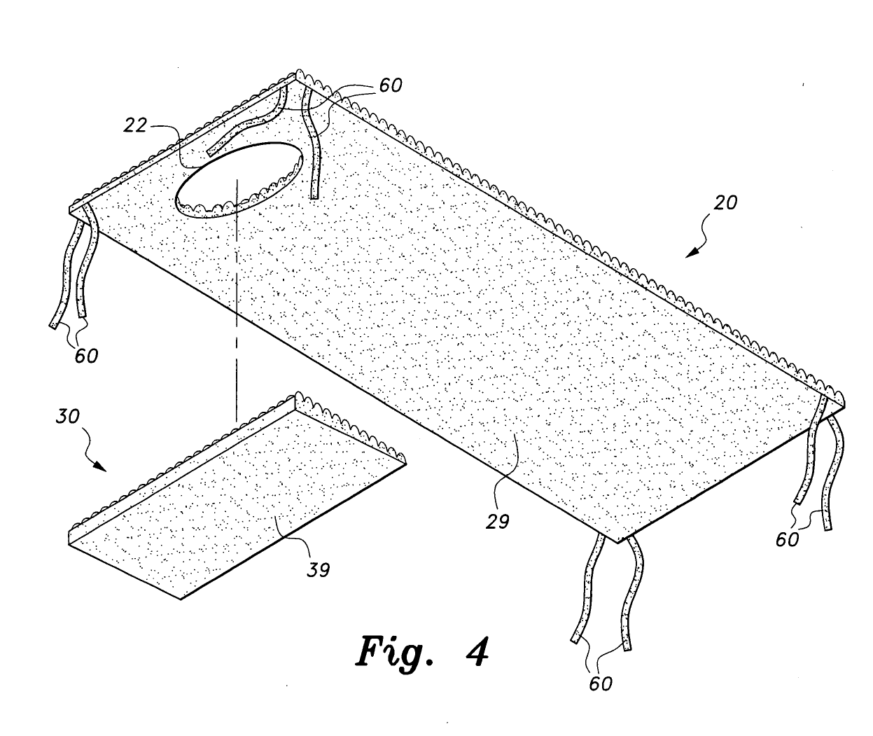

FIG. 5 is a perspective view of the body support pad and chest support pad of an alternative embodiment of the subject mattress with chest aperture.

Similar reference characters denote corresponding features consistently throughout the attached drawings.

### DETAILED DESCRIPTION OF THE PREFERRED EMBODIMENTS

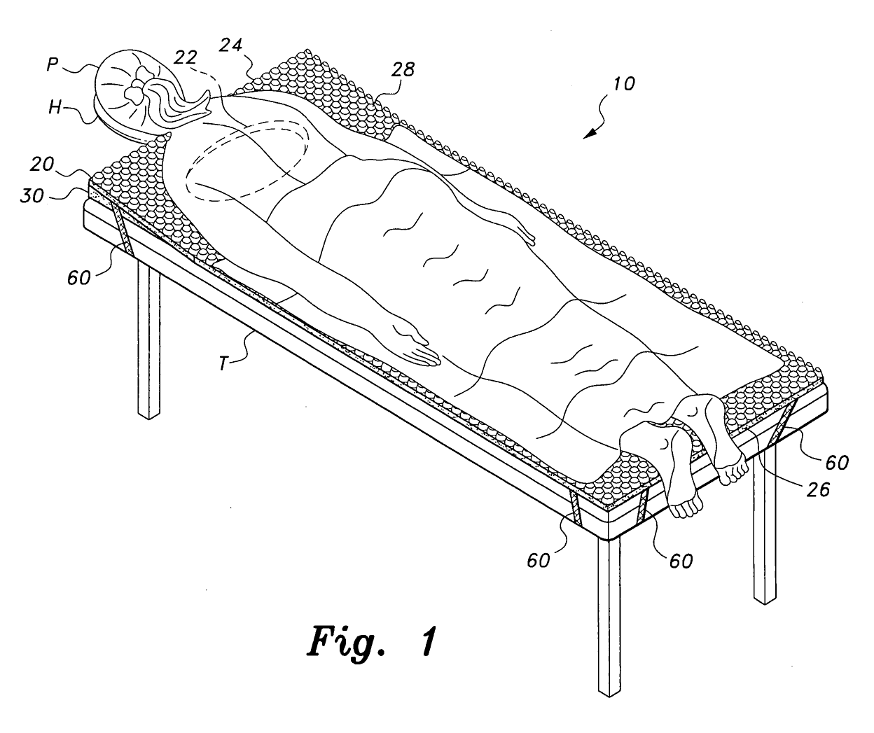

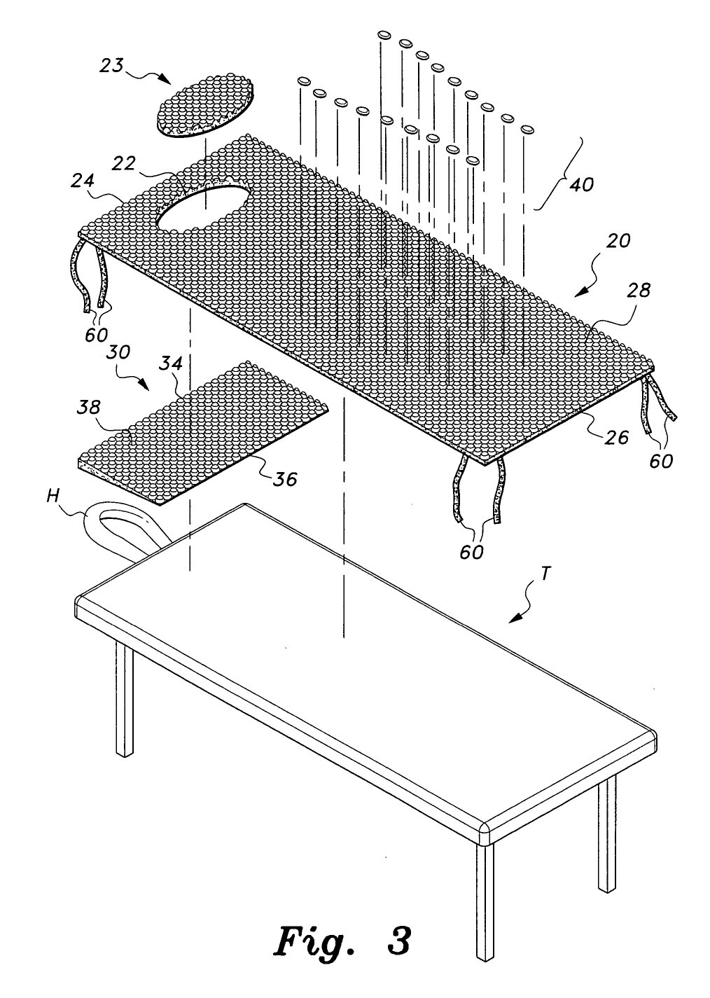

The present invention is a mattress with chest aperture, designated generally as 10 in the drawings. FIGS. 1, 2 and 3, show the mattress 10 disposed on a surface, such as a massage table T. The mattress 10 includes at least a body support pad 20, but may also include a chest support pad 30. The body pad 20 has a head end 24, a selectively closable chest aperture 22 extending through the pad 20 adjacent the head end 24, a removable chest insert pad 23, a pair of opposed sides, and a foot end 26. Further, the pad 20 may have an egg crate-like top surface 28. The chest support pad 30 has a head end 34, a foot end 36 and a top surface 38, which may also have an egg crate-like surface.

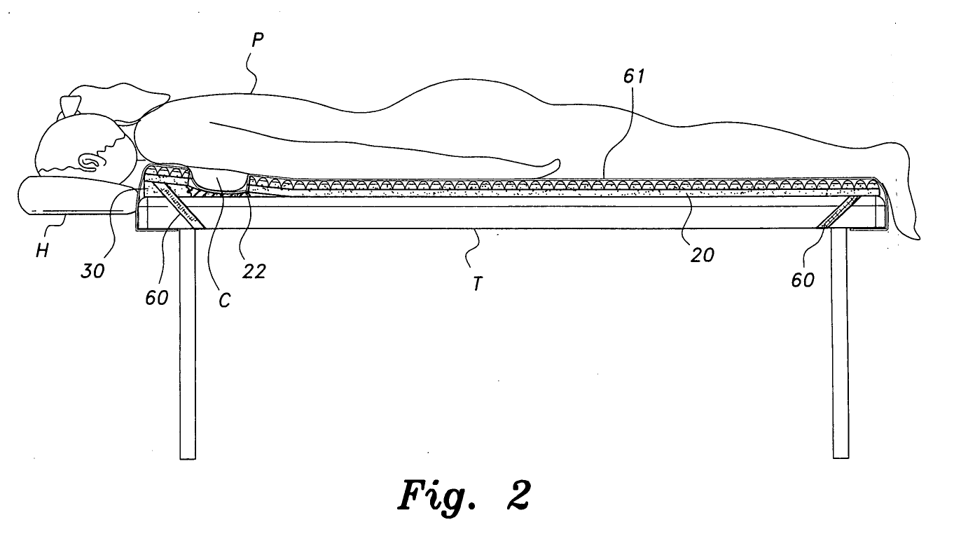

In practice, a fitted sheet may be used to hold the body pad 20 and the chest support pad 30 to the table. A flat sheet may be placed over the fitted sheet to provide a flexible, comfortable surface for the user to lie on. (The sheets are omitted from FIGS. 1 and 2 in order to show details of the mattress.) Optionally, the mattress 10 may be secured to the table T by fasteners 60, which may be tie fasteners or any other suitable fasteners.

The chest aperture 22 passes through the entire thickness of the body pad 20, creating a chest cavity with either table T or the chest support pad 30. At least a portion of the chest C of the person P, such as the user's breasts, rests within the chest cavity formed by the aperture 22. Because the chest support pad 30, when used, lies between the body pad 20 and the table T, the chest C of the person P neither contacts the generally cold, hard surface or upholstery pad of the table T, nor experiences uncomfortable pressure on the chest, thereby allowing the person P to lie comfortably in the prone position. When the user is prone on the mattress 10, the head of the person P extends beyond the mattress 10 and is propped on a head rest H of the table T.

The body pad 20 is a generally rectangular pad designed to fit massage tables T. The pad 20 may be between approximately 27 inches to 33 inches wide and approximately 73 inches long, but can be half-sized or square shaped to support only half of the person's P body, depending on the needs and desires of the user. The body pad 20 has a thickness of approximately 3 inches to cushion the body as it lies on the table T. The chest support pad 30 is preferably approximately 14 inches long, has a width corresponding to the width of the table T, and is approximately 1 inch thick. The chest support pad 30 may be rectangular or oval shape in contour, and may, with respect to height, be wedge-shaped, having a slight incline to raise the head, neck, or shoulders approaching the head rest H for the patient's comfort. Preferably, when the chest support pad 30 has a substantially wedge-shaped contour, the front end has a height of approximately 2 inches, which decreases to the vertex formed at the rear end. The chest support pad 30 is flexible and resilient, and may be substantially compressed if the patient's chest extends far enough into the chest cavity.

Both the body pad 20 and the chest support pad 30 are made of fire-resistant, furniture grade material and may be made of memory foam or similar soft, cushion material, such as Posture-Temp™ material. The bottom surface of the body pad 20 and the chest support mattress 30 may be covered with non-slip material 29, 39, respectively, to provide additional support and to prevent the mattress 10 from sliding when positioned on the table T or other surface.

In use, the chest support pad 30 is placed on the table T, followed by the body pad 20. A fitted sheet is then placed over the body pad 20 to secure the pad 20 and the chest support pad 30 on the table T. The tie fasteners 60 and the non-slip material 29, 39, if present, will also help retain the body pad 20 and the chest support pad 30 on the table T. Once the fitted sheet is placed over table T, holding the pad 20 and the chest support pad 30 in place, a flat sheet may be placed over the fitted sheet to provide a surface on which the person P may recline.

When the person P lies supine on the mattress 10, the chest insert pad 23 is placed in the chest aperture 22, forming a uniform flat surface, properly supporting the person's back. When the person P is lying prone, the chest insert pad 23 is removed from the chest aperture 22, forming the chest cavity described above. At the base of the chest cavity, the chest support pad 30 is exposed, providing a soft contact surface for the chest C disposed in the chest cavity. Thus, when the person P is lying prone, the pad 20 functions to allow a person to lie comfortably without undue pressure on the chest by creating a chest cavity for accommodating the chest C of the person P.

The top surface 28 of the mattress 10 may be an egg crate-like surface, which allows a massage therapist to place massage stones 40 on the mattress 10 without fear of the stones 40 sliding or moving out of position. The massage therapist places the mattress 10 on the table T or other flat surface, arranges the massage therapy stones 40 in the peaks and valleys of the egg crate-like top surface 28 of the mattress 10 above either sheets or towels (the stones may also be covered with sheets or towels, if desired), and then directs a person to lie supine on top of the stones that are placed on top of the mattress 10. Thus, when the person P is lying supine, the pad 20 functions to allow a person to lie comfortably and also retain the stones 40 in a desired pattern.

Although the body support pad 20 has been shown with an egg crate-like top surface 28 in the drawings, it will be understood that the top surface 28 of the body pad 20 may be smooth when the mattress 10 includes the chest support pad 30. Further, the mattress 10, including the individual components thereof, may be covered with a sheet of waterproof material, such as vinyl. The sheet may be custom fitted to cover mattress 10 alone or to cover mattress 10 and the underlying table.

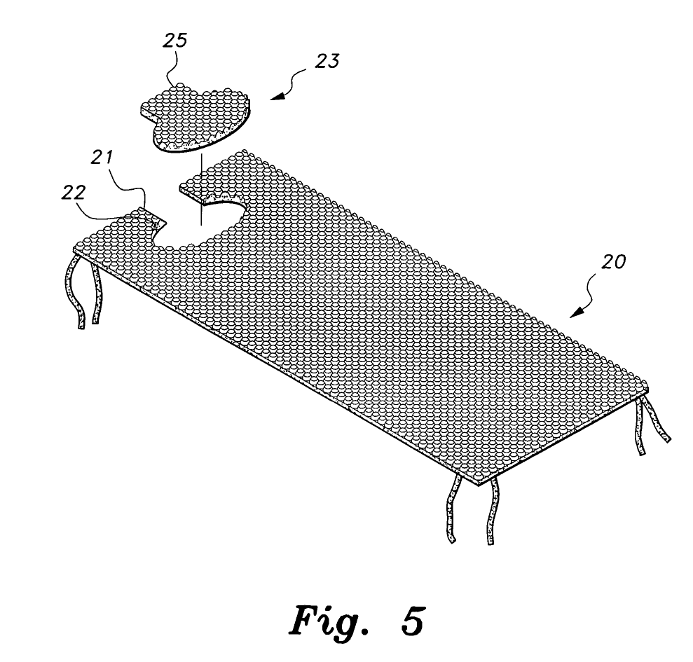

In the embodiment illustrated in FIG. 5, the body support pad 20 has a channel 21 formed adjacent the front edge thereof, which is in communication with the chest aperture 22, as shown. Further, the chest insert pad 23 is provided with a corresponding tab 25, which is received within channel 21 when chest insert pad 23 engages chest aperture 22. Tab 25 is approximately 4 inches wide and 3.5 inches long in the preferred embodiment, however the dimensions of tab 25 may be increased or decreased depending on the needs and desires of the user. When chest insert pad 23 is removed from body support pad 20, channel 21 provides an open region for the comfortable positioning and reception of the user's neck therein.

Mattress 10 provides a comfortable support surface for massage therapy, chiropractic care, physical therapy, esthetics, energy work and the like. The mattress 10 may be used as a full mattress, with the insertion of chest insert pad 23 within aperture 22, or may be used in situations where a chest receiving aperture is necessary for the comfort of the user, such as during massage therapy for large-breasted women or in hospitals for female patients suffering from breast-related conditions.

It is to be understood that the present invention is not limited to the embodiments described above, but encompasses any and all embodiments within the scope of the following claims.

I claim:

1. A mattress with chest aperture, comprising:
a body support pad having a head end, a foot end opposite the head end, and opposing sides extending between the head and foot ends, the body support pad defining a top surface and a selectively closable aperture disposed adjacent the head end adapted for receiving a chest of a person lying prone on the body support pad;
a chest insert pad removably disposed in the aperture for closing the aperture when the person lies supine on the body support pad; and, a chest support pad removably disposed under the body support pad adjacent the head end, the chest support pad extending beneath the aperture defined in the body support pad.

2. The mattress with chest aperture as recited in claim 1, further comprising securement means for securing said body support pad to a support surface.

3. The mattress with chest aperture as recited in claim 1, wherein said top surface of said body support pad has an egg crate-like contour, said top surface defining a plurality of alternating peaks and troughs, each said trough being sized and shaped to receive a massage stone.

4. The mattress with chest aperture as recited in claim 3, wherein said chest support pad has an upper surface having an egg crate-like contour, said upper surface defining a plurality of alternating peaks and troughs, each said trough being sized and shaped to receive a massage stone.

5. The mattress with chest aperture as recited in claim 1, wherein said chest support pad has a substantially wedge-shaped contour.

6. The mattress with chest aperture as recited in claim 1, wherein said chest support pad has a lower surface and said body support pad has a lower surface, said lower surfaces of said chest support pad and said body support pad being coated with a high friction material to prevent slippage of said chest support pad and said body support pad when said chest support pad and said body support pad are positioned on a support surface.

7. The mattress with chest aperture as recited in claim 1, wherein said head end of said body support pad has an opening formed therethrough, said opening connecting said aperture with a front edge of said body support pad, said opening being sized and shaped to receive the neck of the person when the person lies in the prone position on said body support pad.

8. The mattress with chest aperture as recited in claim 7, wherein said chest insert pad has a tab formed thereon and projecting therefrom, said tab being sized and shaped to fill said opening when said chest insert pad is received within said aperture.

9. A mattress with chest aperture, comprising:
a body support pad having a head end, a foot end opposite the head end, and opposing sides extending between the head and foot ends, the body support pad defining an egg crate-like top surface and a selectively closable aperture disposed adjacent the head end; and,
a chest insert pad removably disposed in the aperture for closing the aperture when the person lies supine on the body support pad.

10. The mattress with chest aperture as recited in claim 9, further comprising a chest support pad removably disposed under the body support pad adjacent the head end, the chest support pad extending beneath the aperture defined in the body support pad.

11. The mattress with chest aperture as recited in claim 9, further comprising securement means for securing said body support pad to a support surface.

12. The mattress with chest aperture as recited in claim 9, wherein said egg crate-like top surface of said body support pad defines a plurality of alternating peaks and troughs, each said trough being sized and shaped to receive a massage stone.

13. The mattress with chest aperture as recited in claim 12, wherein said chest support pad has an upper surface having an egg crate-like contour, said upper surface defining a plurality of alternating peaks and troughs, each said trough being sized and shaped to receive a massage stone.

14. The mattress with chest aperture as recited in claim 10, wherein said chest support pad has a substantially wedge-shaped contour.

15. The mattress with chest aperture as recited in claim 10, wherein said chest support pad has a lower surface and said body support pad has a lower surface, said lower surfaces of said chest support pad and said body support pad being coated with a high friction material to prevent slippage of said chest support pad and said body support pad when said chest support pad and said body support pad are positioned on a support surface.

16. The mattress with chest aperture as recited in claim 9, wherein said head end of said body support pad has an opening formed therethrough, said opening connecting said aperture with a front edge of said body support pad, said opening being sized and shaped to receive the neck of the person when the person lies in the prone position on said body support pad.

17. The mattress with chest aperture as recited in claim 16, wherein said chest insert pad has a tab formed thereon and projecting therefrom, said tab being sized and shaped to fill said opening when said chest insert pad is received within said aperture.
